(19) United States
(12) Patent Application Publication
(10) Pub. No.: US 2003/0034183 A1
(43) Pub. Date: Feb. 20, 2003

(54) Method for weighing a load and for controlling loading

(76) Inventor: Jyrki Kortesmaki, Nokia (FI)

Correspondence Address: SWIDLER BERLIN SHEREFF FRIEDMAN, LLP, 3000 K STREET, NW, BOX IP, WASHINGTON, DC, 20007, US

(21) Appl. No.: 10/171,772

(22) Filed: Jun. 17, 2002

(30) Foreign Application Priority Data
Jun. 20, 2001 (FI) 20011306

(51) Int. Cl. G01G 19/52; G01G 19/14

(52) U.S. Cl. 177/142; 177/147

(57) ABSTRACT

Method in a stacker crane for weighing a load, which comprises a lifting carriage, motor means which are arranged to lift and lower the lifting carriage, a lifting member that transmits tensile stress and on the support of which the lifting carriage is suspended for movement and on which the motor means exert a tensile effect for the movement of the lifting carriage, and first sensor means which are arranged to determine the position of the lifting carriage and generate a first signal, control means, second sensor means which are arranged to generate a second signal that is proportional to the amount of the lifting member that is fed via the motor means. In the method the elongation of the lifting member is determined that is caused by the load positioned in the lifting carriage, said elongation being proportional to the difference of the first and second signal when the position of the lifting carriage is also determined on the basis of the second signal, and the weight of the load is determined by means of a calculation algorithm, said weight corresponding to the produced elongation. In the calculation the stretching length of the lifting member and the predetermined spring constant of the lifting member that describes the elongation of the lifting member as a function of the loading and the stretching length, are taken into account in addition to the elongation.

### TECHNICAL FIELD

The present invention relates to the method in a stacker crane. The present invention also relates to a stacker crane and a system for weighing a load.

### BACKGROUND ART

As is well known, in automatic flexible manufacturing systems, or automatic storage systems for example various loading stations are used, by means of which work pieces located e.g. on a pallet are supplied to the system for machining, storing or other kind of handling. Typically, the system also comprises various automatic lift and transfer devices, which transfer work pieces from a loading station to the system, to be stored on a storage rack or to be processed further, and back. Lift and transfer devices include for example stacker cranes that handle different kinds of bases, trays, pallets or work pieces and comprise for example suitable devices such as transfer forks, telescopic forks, lifting mechanisms or the like for handling of the aforementioned pieces. These devices are typically placed in a carriage, which moves in the vertical frame structure of the stacker crane, driven for example by means of a cable drive or a chain drive. The lift and transfer device is typically arranged on top of the floor level and it moves on the support of rails.

Stacker cranes also transfer pieces to different manufacturing stations that have automatic handling devices of their own especially for handling of a pallet. Stacker crane systems are controlled automatically by methods known as such by means of a control program stored in the control means, to which control program the necessary information for example on the pieces to be handled, storage locations and desired transfers is entered.

The motor drives of stacker cranes must be monitored for underloading and overloading. By monitoring the loading it is possible to detect error situations and defects in the apparatus. Underloading occurs for example in a situation where lowering lifting forks rest against the horizontal structures of the shelving structure. The situation occurs for example in an error situation in which telescopic forks remain in a protruding position. Underloading occurs for example in a situation where raising lifting forks or the piece to be handled rest against the horizontal structures of the shelving structure. Overloading can also be effective in a situation where the load is too heavy to be handled. It is important to determine the weight of the load to be able to avoid underloading and overloading situations, and the obtained information can also be used by other systems in a desired manner.

Thus, for the purpose of weighing a load it is common that a weighing apparatus is placed in the end of the lifting chain or cable, for example a separate strain-gauge sensor that measures the elongation caused by the loading in the lifting member. The electric signals obtained from the sensor are processed by means of a control card arranged for this purpose, from which card an output signal is obtained that is proportional to the weight. The signals can also be input to the control system of another system.

There is, however, such a problem that malfunctions often occur in the sensor system and in the control electronics in an overloading situation. Furthermore, it is difficult to place it in a protected manner in the attachment between a lifting chain or cable and lifting carriage.

### DISCLOSURE OF INVENTION

It is an aim of the present invention to eliminate the problems presented above. The invention is based on the idea that a new system is used for determining the weight of the load, wherein it is possible to omit the aforementioned separate sensor entirely. The invention is also based on the idea that other sensors are used for determining the weight, which sensors nearly always already exist in stacker cranes.

On the basis of the weighing result it is also possible to calculate what the loading should be in a given situation, and thus it is possible to monitor over- and underloading. When a value deviating from the measurement of the loading i.e. weight measurement is obtained, it is possible to give an alarm.

It is a special advantage of the invention that the number of sensors can be reduced to increase the reliability of the apparatus and to prevent malfunctions. By means of the invention it is also possible to arrange the monitoring of over- and underloading in old devices that lack said function. A special advantage of a preferred embodiment of the invention is that the calibration of the components for the function of weighing and monitoring can be conducted automatically, wherein the number of variables measured manually from the system is small and it is possible to repeat the calibration easily and rapidly.

### BRIEF DESCRIPTION OF DRAWINGS

In the following, the invention will be described in more detail with reference to the appended drawings, in which:

FIG. 1 shows a stacker crane and control means according to a prefered embodiment of the invention.

### MODES FOR CARRYING OUT THE INVENTION

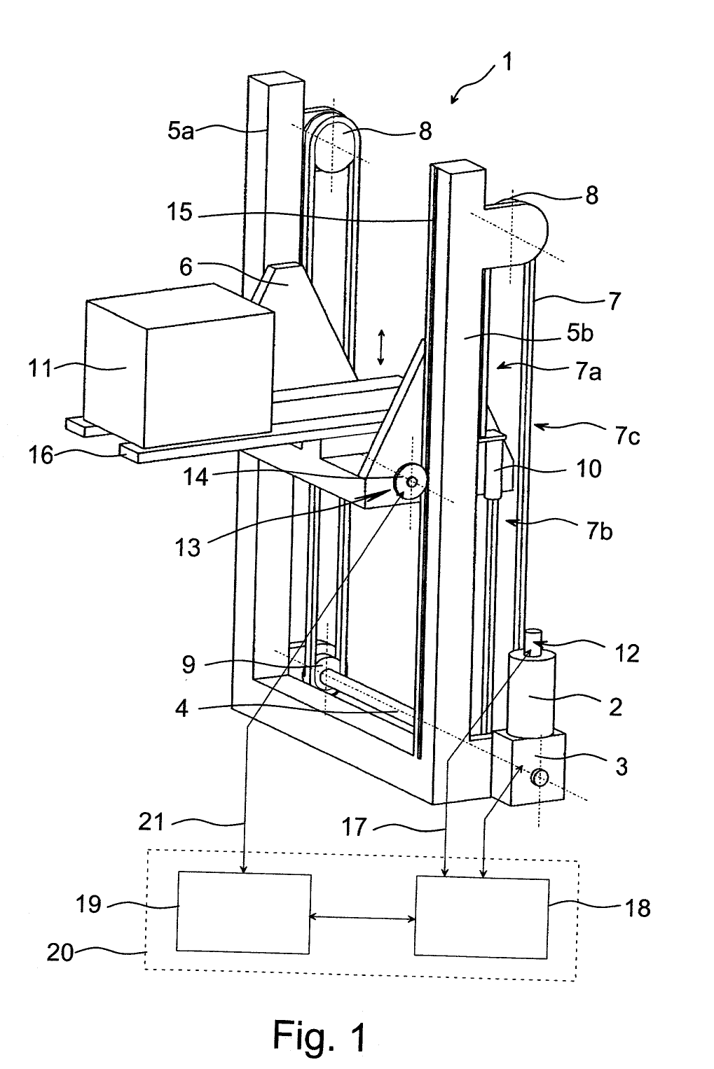

FIG. 1 shows a simple stacker crane 1 in which the invention is applied. The stacker crane 1 is presented without a rail system positioned underneath the same, on the support of which the stacker crane 1 moves (X-direction) and which is known as such. The stacker crane 1 can also comprise a rail system placed above or on the side the same, the stacker crane 1 resting on said rail system known as such.

The stacker crane 1 comprises a lifting motor 2, the force of which is transmitted via a gearing 3 to a lift axis 4, which is normally horizontal. The crane 1 comprises a frame structure containing two vertical guide beams or structures 5a, 5b, which are located within a suitable distance from each other and between which the lifting carriage 6 is placed in a movable manner. The lifting carriage 6 can be lifted and lowered (Y-direction) on the support of the beams 5a, 5b and by means of a known guide arrangement (not shown) which is placed in the beams 5a, 5b and the lifting carriage. The frame structure moves back and forth (X-direction) on the base by means of a rail system.

The lifting carriage 6 is moved by means of a lifting member, a chain 7 which is lead underneath the lift axis 4 to a sheave 8 and further above the sheave 8 to the lifting carriage 6. The sheave 8 rotates around a horizontal axis (X-direction). There are typically at least one chain in connection with each beam 5a, 5b, wherein a driving chain wheel 9 is arranged on the lift axis 4, said chain wheel being in a functional connection with the chain 7. The lifting motor 2, the chain wheel 9, the gearing 3 and the lift axis 4 form the necessary motor equipment to move the chain 7 and the lifting carriage 6. The chain wheel 8 functioning as a sheave rotates freely and reverses (Y-direction) the direction of the chain 7. Both ends 7a, 7b of the chain 7 are attached to the lifting carriage 6. The first end 7a that comes from the sheave 8 is attached directly to the lifting carriage 6 and the second end 7b that comes from the chain wheel 9 is attached to the lifting carriage 6 via a draw spring 10 of spring members. The draw spring 10 functions as a prestressing spring of the chain 7 and compensates the variations in the length of the chain 7.

The loading of the load 11 does not affect the loading of the chain 7 in the vertical section 7b, which is located between the lifting carriage 6 and the chain wheel 9, and at the same time between the lifting carriage 6 and the motor means. The load 11 is effective especially in the vertical section 7a which is located between the lifting carriage 6 and the chain wheel 8 and in the section 7c which is located between the chain wheels 8 and 9. Overloading causes tightening of the chain 7 and underloading loosening of the same. In prior art, loading has been monitored by placing separate strain-gauge sensors in the first end 7a of the chain. Thus, the sensors measure both the loading caused by the load and the loading caused by the lifting carriage. Furthermore, it is necessary to take into account the loadings caused by friction in the guide arrangement.

Alternatively, the chain 7 can be replaced with a cable, wherein the wheel 8 is replaced with a sheave suitable for the cable, and the draw to the cable is transmitted in a suitable manner. The chain wheels 9 can also be replaced with a rope or cable drum placed on the lift axis, in which the cable is wound when the carriage 6 is lifted up and from which the cable is unwound when the carriage 6 is lowered down. Thus, the section 7b of the cable is not necessary. Alternatively, the chain 7 is replaced with a cogged belt or the like. The lifting member 7 that transmits tensile stress is typically a chain, but depending on the maximum load and the target of use, the structure of the same may vary. The method is well suited for various kinds of lifting members 7 that strech, are flexible and transmit tensile stress, so that the carriage 6 could be moved. The carriage 6 is lowered down by means of gravity and the load 11.

The stacker crane 1 also comprises sensor means 12 for determining the speed of rotation of the motor 2. The speed of rotation is input as a signal typically to the control device 18 of the electric supply of the lifting motor 2 which contains a device for adjusting the position, operating by means of a program. The signal 17 is for example a pulse sequence, wherein by means of calculating the pulses it is possible to determine the shift of the carriage 6 and at the same time the position of the same with respect to a reference position or initial position. The number of pulses is proportional both to the lengt of the carriage 6 and to the length of the shift of the lifting member 7. The control program is positioned for example in the driving unit 18 of the motor 2, which is for example a servo drive or a frequency transformer, or in another control device 19, for example in programmable logic. The servo drive 18 and the logic 19 constitute feasible control means 20 for controlling the stacker crane 1. The function of the device for adjusting the position as well as the function of the control program are known as such and the apparatus alternative can be selected according to the needs and properties at a given time.

The signals and information to be transmitted vary according to the selected configuration. The term signal refers to analog or digital signals suitable for the purpose that indicate the selected variable directly as a numerical value, a signal level or by means of a signal change. More accurate applying of the calculation algorithms in the configuration in question is obvious for anyone skilled in the art on the basis of this description and by using the couplings, inputs and outputs of said apparatus for processing the signals, and desired functions and programming tools for processing the numerical values indicated by the signals.

The pulse sensor may be of a rotating type, for example a simple optical or magnetic sensor. Typically, the pulse sensor has a resolution of 1024 to 4096 pulses per revolution, wherein the speed of rotation is measured by determining the amount of generated pulses within a time unit. The pulse frequency is proportional to the speed of rotation. The sensors often contain electronics that convert the output signal into a rectangular signal that is processed in a desired manner. The optical sensor contains a disc that comprises translucent and opaque sectors at fixed intervals. The disc is placed between a light source and a photosensitive cell (visible light or infrared), wherein a variable pulse is attained from the photosensitive cell. The accuracy of the sensor depends on the number of the sectors. The pulse sensor can also identify the direction of rotation if two photosensitive cells or two wafers are used, wherein the direction of rotation is obtained from the phase shift of the pulses. The sensor can also comprise a wafer which gives a so-called zero pulse on every revolution for calibration purposes.

Alternatively, the pulse sensor can also be magnetic, wherein a rotating sensor grid (for example a ring magnet) is formed of magnetic and nonmagnetic sectors. An impulse is obtained from a detector every time a magnetic part passes by. The detector is for example a reading coil and the voltage induced thereto is modulated by magnetic elements. By means of filtering and electronics a rectangular wave is obtained as an output signal.

The sensor means 12 are also suitable for determining the position, wherein when the system is started a reference point or a zero point is determined from which the counting of pulses begins. Each pulse is proportional for example to the shift of the lifting carriage 6, depending for example on the transmission of the gearing 3, wherein by summing the pulses it is possible to determine the location of the lifting carriage 6. In the control means 20 it is also possible to tabulate the position, but typically the height position of the lifting carriage is directly proportional to the number of summed pulses. According to prior art, the pulse sensor means 12 are not suitable as such for determination of the position, because the behaviour of the chain 7, especially the elongation of the same is not known precisely, which would cause errors.

The servomotor is for example an AC servomotor, which is a synchronous motor or an asynchronous motor. For example a synchronous motor comprises a permanently magnetized rotor that rotates in a magnetic field as a result of a stator coil. The coils of the synchronous motor are supplied with a sinusoidal three-phase alternating voltage at the frequency of which the rotor rotates, wherein the speed is adjusted by changing the input voltage by means of a frequency converter. A signal is obtained from the pulse sensor of the motor, which signal is used for controlling the motor for example in position or speed control. The servomotor and the pulse sensor are coupled to a servo-controller, i.e. servoamplifier the function of which is to provide the servomotor with the current required by the same. The amplifier can also be used for controlling the acceleration and deceleration of the motor and for setting of amplification, feedback coupling and ramps.

To the servomotor a control device is connected, typically a programmable logic controller (PLC) or a control computer by means of which the system is controlled. The logic provides the amplifier for example with the setting signals for location and speed. The controller, in turn, provides the logic with information on the position, speed or acceleration, or they are determined by means of the logic, which is connected directly to the pulse sensors. The control computer may be provided with a separate control card of its own for position adjustment, which control card can be programmed for example by means of the software of the control computer. The servoamplifier 18 and the logic 19 constitute programmable control means 20 with which the weighing and monitoring is controlled by means of a control program or control programs. The final configuration depends on the components or control principles that can be selected to be used or that are already in use at a given time. The necessary control modes and calculation algorithms are arranged in the control means to perform and activate the functions described hereinbelow. The control modes are integrated in the other functions and control of the stacker crane 1 in a desired manner.

Because the position of the lifting crane 6 is measured indirectly with the sensor means 12, the chain 7 and the elongation of the same can cause significant errors in the measurement. Therefore the position is typically measured from a position sensor 13 located in the lifting carriage 6, which is for example a pulse sensor that travels along with the lifting carriage 6. The position sensor 13 comprises a cogged wheel 14 that rotates in a toothed bar or a cogged belt 15. The vertical (Y direction) toothed bar 15 is attached to a pillar 5a or 5b. The pulse sensor 13 is attached on the axis of the cogged wheel 14.

The sensor 13 can also be an incremental pulse sensor that is suitable for measurement of linear movement and whose graduated scale is attached to the pillar 5a or 5b. The graduated scale may be reflecting, wherein the light source and the photosensitive cell are positioned in the lifting carriage. It is also possible to use magnetic incremental pulse sensors. The position sensors may also be based on an absolute operating principle, wherein the position is coded by means of a binary, Gray or BCD code. The sensor 13 is arranged so that the signal 21 given by the same would at the same time correspond to the location of the lifting carriage 6 and at the same time the location of the stretching end of the chain 7, and thus it is possible to determine the elongation accurately by comparing the signal to the signal of the sensor 12. The sensor 12, in turn, is arranged so that the signal 17 given by the same would correspond as well as possible to the length of the member 7 fed from the motor means past the chain wheel 9. The closer the measurement point is to the location (e.g. chain wheel 9) to which the stretching section of the member 7 is supported and from which it begins, the more accurate results are obtained.

TABLE 1

| | |
|---|---|
| Y_{AP} | Position of the lifting carriage measured from the sensor of |
| | the lifting carriage [mm] |
| Y_{MP} | Position of the lifting carriage measured from the sensor of |
| | the motor [mm] |
| K_{CH} | Spring constant of the lifting member [0.001 mm/(kg.mm)] |
| L_{MAX} | Maximum stretching length of the loaded lifting member |
| | [mm] |
| K_{CT} | Spring constant of the prestressing springs [mm/kg] |
| L_{CT} | Loading of the prestressing springs [kg] |
| L_{LC} | Weight of the lifting carriage [kg] |
| A_{LC} | Acceleration of the lifting carriage [m/s2] |
| a | Gravitational acceleration of earth [m/s2] |
| L_{TOT} | Total weight loading the lifting member [kg] |
| dY_{CH} | Measured elongation of the lifting member [mm] |
| A_{COMP} | Acceleration forces of the lifting carriage [kg] |
| Z_{COMP} | Loading forces of the lifting carriage [kg] |
| L_{M} | Weight of the load to be lifted [kg] |

Information according to Table 1 is used in the measurement of the load.

According to the invention it is now possible to determine the weight of the load 11 without a separate sensor system and electronics arranged for this purpose. The basic idea is that the sensor 12 that is typically a pulse sensor, also provides information on the position which is not used according to prior art. It is, however, used for calculation of the elongation of the chain 7 caused by the loading. In the following, the measures and calculation will be examined. The weighing is called a control mode D.

The loading causes an elongation dY_{CH} in the lifting member 7 in the following manner:

dY_{CH}=Y_{MP}−Y_{AP}. (1)

From the elongation dY_{CH} of the lifting member 7 it is possible to calculate the weight L_{M} of the mass 11 loading the lifting member 7 by means of a calculation algorithm (2) in which the elongation properties of the lifting member 7 are taken into account by means of the spring constant K_{CH} of the lifting member:

$${L}_{M} = \frac{{dY}_{CH}}{( {K}_{CH} \cdot ( {L}_{MAX} - {Y}_{AP} ) )} . \qquad ( 2 )$$

The spring constant K_{CH} is determined for the lifting member 7 in such a manner that the stretching length of the same is also taken into account. The stretching length of the lifting member 7 at a given time changes and it depends on the position of the lifting carriage 6, and it is the maximum stretching length L_{MAX} of the lifting chain 7 in relation to the position information Y_{AP} of the lifting carriage 6, which at the same time indicates how much the lifting member 7 has shortened. The position of the lifting carriage 6 is set into zero (Y_{AP}=0, Y_{MP}=0) when it is in its functional lower position in which the stretching length of the lifting member 7 is also in its maximum L_{MAX}. The stretching length can also be determined by means of the position information Y_{MP}, but in that case the error resulting from the elongation is also present.

The parameter L_{M} is preferably determined at the moment when the lifting carriage 6 is stopped or in a steady lifting or lowering movement (acceleration is zero) and the lifting forks 16 are pulled inside, wherein the weight is divided as centrally as possible. Thus, the deflections and tiltings caused by the extension of the forks 16 affect the measurement result of the position sensor 13 as little as possible. Especially the acceleration of the lifting carriage 6 for its part affects the measurement result, wherein for example in a lifting acceleration and lowering deceleration the loading is increased.

The effect of the weight L_{LC} of the empty, unloaded lifting carriage 6 as well as the effect of the springs 10 to the elongation of the lifting chain 7 can be compensated away in such a manner that the sensor 12 in the motor is scaled so that it shows the same position with the actual position sensor 13 when the empty lifting carriage 6 is moved. Thus, it is not necessary to know the weight L_{LC} of the lifting carriage 6 or the effect of the prestressing springs 10. If the aim is to divide the total loading on different sections, it is necessary to know the weight L_{LC} and the properties of the springs 10. When the weight L_{LC} is known, it is also possible to determine for example the additional load caused by the acceleration in more detail. It has to be possible to calculate the additional loading, so that the prevailing loading could be monitored.

The weight L_{LC} of the empty lifting carriage 6 remains constant. Possible changes as well as the permanent elongation resulting from the wearing of the lifting member 7 is taken into account by performing the aforementioned scaling and compensation at fixed intervals. As often as possible, always when the apparatus 1 is switched on or even before each weight measurement of the load 11, it is necessary to set the initial readings of the sensors 12 and 13 so that they match each other or they must be set to zero. In this case, the initial readings correspond to the functional lower position of the lifting carriage 6. It is possible to conduct measurements during the normal operation of the stacker crane 1, or it can be set to weigh the loads located in the shelving and/or receiving stations in a desired manner.

It should be noted that in the sensor means 12 and 13 the number of pulses per unit of length can vary, which can be corrected by means of different scalings and scaling factors or by means of tabulation to calculate the actual difference in position. In practice, the elongation also includes errors caused by other structures, wherein the positions Y_{AP} and Y_{MP} always differ from each other in a way that is difficult to predict and define. To measure the elongation, it should, however, be possible to exclude other effects. Thus, it is possible to compensate the effects of the weight L_{LC} of the carriage 6 and effects of other structures in the elongation measurement.

Under the control of the control means 20 of the stacker crane 1 the aforementioned compensation is conducted in such a manner that the measurement result of the sensor 12 is scaled so that it shows the same result with the sensor 13, or vice versa. In the compensation (control mode A) an empty lifting carriage 6 is used that is driven from the lower limit of the movement range of the carriage 6 to the upper limit and in both cases the readings of the sensors 12 (Y_{MP1}, Y_{MP2}) and 13 (Y_{AP1}, Y_{AP2}) are registered. A new scaling factor K′ is calculated by dividing the difference of the readings (Y_{MP2}−Y_{MP1}) of the sensor 12 with the difference of the readings (Y_{AP2}−Y_{AP1}) of the sensor 13 and multiplying the old scaling factor K with the result. Before said control mode it is ensured that the lifting carriage 6 is empty or it is emptied, and in the end the control gives the parameter K to be used. From the position Y_{MP} it is now possible to determine a reading corresponding to the position Y_{AP}, or vice versa. It is now easy to calculate the difference of positions and determine the elongation corresponding to the difference in the units of length, because the relation is typically linear. The scaling factor can also be determined in a reversed format. In the control mode A the aim is to experimentally find a correspondence between the signals of the sensors, wherein the effect of the empty lifting carriage 6 and structures etc. is at the same time excluded. Thus, it is possible to obtain the elongation of the lifting member 7 directly from the signals.

Especially the operating principle of the sensor 13 can vary, and it can be for example analog, but the signal still indicates the position of the lifting carriage 6 in the desired manner. The signal can be converted to the desired format by means of different coefficients and scaling factors. The sensor 13 can also comprise control electronics that gives a signal proportional to the position. At least in this description the proportionality refers to the fact that on the basis of the signal and by using setting parameters and coefficients suitable for the calculation it is possible to determine the desired position or speed information for example from a digital signal and voltage or current signal. Preferably, the sensor 13 is a pulse sensor. The sensor 12 is preferably a sensor ready-made in the motor 2, by means of which sensor the speed of the motor is measured at the same time. Typically, the sensor is a pulse sensor the pulses of which can be utilized to determine position, speed and acceleration simultaneously. Thus, it is not necessary to place a new sensor in the motor 2, gearing 3 or lift axis 4, wherein the costs and installation work are reduced. One alternative for the sensor 12 is an arrangement similar to sensor 13, which is placed in a fixed position as close as possible to the axis 3, said arrangement being driven by the lifting member 7 for example via a chain wheel. The method for determining a load also functions in said sensor alternative, if the sensor 12 is not of such a type that is suitable for determining the position.

When the weight L_{M} of the load 11 is now known, it can be used in the monitoring of overloading and underloading.

The prestressing springs 10 of the lifting chain 7 located underneath the lifting carriage 6 affect the total loading in the manner described hereinbelow. The effect of the prestressing springs 10 to the loading is described by the parameter L_{CT}. If a lifting cable is used that is wound in a cable drum, this section is omitted in the calculation, but the weight must be compensated according to the weight of the lifting chain 7 on the path located between the height level of the lifting carriage 6 and the height level of the cable drum.

$${L}_{CT} = \frac{{dY}_{CH}}{{K}_{CT}} . \qquad ( 3 )$$

The calculation is based on the fact that when the load extends the lifting member 7, the prestressing spring 10 becomes shorter respectively. Thus, the prestressing springs 10 affect in the same direction as the loading of the load 11 and the effect of gravity. Thus, if the aforementioned compensation is used that at the same time takes into account the loading of the prestressing springs 10, the load 11 is in fact an equal amount heavier as the spring 10 is shortened. This must be considered when the total load is defined in different situations. It is typical for a pressure spring that the force, i.e. mass multiplied with the gravitational acceleration is directly proportional to the spring constant K_{CT} and change of length dY_{CH}.

The combined weight of the lifting carriage 6 (parameter L_{LC}) and the load 11 to be lifted (parameter L_{M}) streches the lifting member 7 also during acceleration and deceleration stages and increases the total loading, i.e. total weight in the following manner:

$${A}_{COMP} = \frac{( ( {L}_{M} + {L}_{LC} ) \cdot {A}_{LC} )}{a} . \qquad ( 4 )$$

In the weight of the lifting carriage 6 it is also possible to take into account structures that move along with the lifting carriage 6, for example the sensor means 13 and different parts of the guide arrangement. The acceleration A_{LC} of the lifting carriage 6 can be calculated on the basis of the change in the speed of the lifting carriage 6. The speed of the lifting carriage 6, in turn, can be determined on the basis of the pulse frequency of the sensor 12 or by means of the sensor 13. The speed can be obtained directly from the drive 18 of the lifting motor 2 and/or from the control means 20 that are connected to the sensor 12 of the motor 2.

During the loading of the movable load 11, the outwards protruding forks 16 of the stacker crane 6 that function as load reception members, cause the tilting of the position of the lifting carriage 6. This takes place in stacker cranes in which the beam assembly bends intensively during the loading. To avoid the problem, the positioning sensor 13 and the lifting member 7 should be positioned in the axis of symmetry of the beams 5a, 5b. In the calculation it is possible to take into account from which side of the stacker crane 1 the load 11 is handled. The stacker crane 1 can handle the load either from both sides or only from the other side, depending on the implementation and for example on the load reception members 16. It is possible to determine the working side on the basis of the working stage selected by other sensors or control of the stacker crane 1. The obtained additional load is:

Z_{COMP}=L_{M}·Z_{L/R}·ZC_{L/R}, (5)

in which Z_{L/R} is the extension (to the left or to the right) and ZC_{L/R} is the compensation coefficient. Generally, the calculation result is not accurate, but it is sufficient for the purpose of monitoring, to produce overloading or underloading alarms. When the load 11 is located in the middle of the carriage 6, the parameter Z_{COMP} is no longer efficient, and the calculation is more accurate as well.

For the purpose of monitoring, the total load L_{TOT} is now attained as a sum of the aforementioned factors, the formulas (2) to (5):

L_{TOT}=L_{M}+L_{CT}+A_{COMP}+Z_{COMP}. (6)

The effect of the weight of the empty lifting carriage 6 to the elongation of the lifting chain 7 can be compensated in such a manner that the sensor 12 in the motor is scaled so that it shows the same reading with the actual position sensor 13 when the empty lifting carriage 6 is moved. Before each measurement the sensor 12 of the motor is calibrated so that it shows the same reading with the position sensor 13. Thus, for example a permanent change in the elongation resulting from the wearing of the chain is not capable of causing an error in the measurement result. The formula (6) shows that L_{TOT}=0, when the lifting carriage 6 is stationary and empty, wherein the elongation dY_{CH} is not taken into account either because of the compensation. It is possible to supplement the formula (6) with the section L_{LC} of the carriage 6, especially when the compensation has not been conducted. L_{CT} has to be summed up as well, as was mentioned in connection with the formula (3).

In the formula (2) the spring constant K_{CH} of the lifting member 7 is an unknown factor. It is possible to determine the spring constant for the new lifting member 7 for example by means of tests in connection with the manufacture, but it is not reasonable to detach the lifting member from the stacker crane 1 at a later stage to check the spring constant. As the wearing and properties change during time, the spring constant should, however, be determined so that the measurement of weight would be reliable.

The spring constant K_{CH} of the lifting member can be calculated by means of the formula:

$${K}_{CH} = \frac{{dY}_{CH} \cdot {K}_{CT}}{( {L}_{MAX} - {Y}_{AP} ) \cdot ( {L}_{M} \cdot {K}_{CT} - {dY}_{CH} )} , \qquad ( 7.1 )$$

which can be derived from the sum of the formulas (2) and (3). It is not necessary to take into account the weight of the lifting carriage 6, because it is compensated in connection with the compensation of the sensors 12, 13. The prestressing springs 10 must be taken into account because the length of the chain 7 and thus also the length of the prestressing spring 10 change during the measurement. The change in the prestressing spring 10 must be taken into account as a sum. If the structure does not contain prestressing springs 10, the formula is the following one:

$${K}_{CH} = \frac{{dY}_{CH}}{( {L}_{M} \cdot ( {L}_{MAX} - {Y}_{AP} ) )} . \qquad ( 7.2 )$$

The setting of the parameter K_{CH} takes place automatically (control mode B), wherein a load 11 as large as possible, with a known weight L_{M} is handled by means of the crane 1, so that the elongation would be as great as possible. Before said control mode it is ensured that the carriage 6 is empty, and the weight of the test load 11 is reported to the control, if necessary. After the loading of the load 11, the elongation dY_{CH} is measured and calculation is conducted, and the result is reported to the control means 20.

Another parameter that can vary and that can be determined automatically is the extensible length L_{MAX}, which can be determined by solving a pair of equations in which the elongations of the lifting member 7 are measured by loading with the standard load 11 when the lifting carriage 6 is in two different positions the distance of which is as large as possible. Thus, by using the formulas (2) and (3) it is assumed that the parameters K_{CH} and L_{M} do not change. K_{CH} is solved on the basis of the formulas and the following pair of equations is obtained:

$$\begin{matrix}{K}_{CH} = ( \frac{{dY}_{CH1} \cdot {K}_{CT}}{( ( {K}_{CT} \cdot {L}_{M} - {dY}_{CH1} ) ( {L}_{MAX} - {Y}_{AP1} ) )} ) \\ = ( \frac{{dY}_{CH2} \cdot {K}_{CT}}{( ( {K}_{CT} \cdot {L}_{M} - {dY}_{CH2} ) ( {L}_{MAX} - {Y}_{AP2} ) )} )\end{matrix} \qquad ( 8 )$$

The result obtained for the parameter L_{MAX} is:

$${L}_{MAX} = \frac{\begin{matrix}( {Y}_{AP2} \cdot {dY}_{CH1} - {Y}_{AP1} \cdot {dY}_{CH2} ) + \\ {dY}_{CH1} \cdot {dY}_{CH2} \cdot ( {Y}_{AP1} - {Y}_{AP2} )\end{matrix}}{( {dY}_{CH1} - {dY}_{CH2} )} . \qquad ( 9 )$$

The prestressing springs 10 must be taken into account in the formula (8) because the length of the chain 7 as well as the length of prestressing spring 10 change during the measurement. A corresponding result is also obtained without the prestressing springs 10. The elongation of the springs 10 without the load 11 has already been compensated, and thus it is only necessary to examine the change in the elongation of the spring 10, which is now the same as the parameter dY_{CH}. The parameter L_{MAX} is determined (control mode C), wherein as heavy a load 11 as possible is taken in the empty carriage 6, said load being transferred as long a distance as possible. In the end of the movement and the calculation the calculated parameter or results are reported to the control 20 for calculation.

The monitoring of the loading in the control mode D is taken in use by taking into account the elongation of the lifting member 7 and the springs 10 that has been measured at low speed with the load 11. It is obvious that the weight of the load 11 can also be reported to the control means 20 of the stacker crane 1 by means of another control system of the system for monitoring of over- and underloading, if said weight is known. If the weight is measured in the crane 1, it is not necessary to arrange a weighing apparatus elsewhere in the system, and the stacker crane 1 can give information on the weight to said system. If necessary, the stacker crane 1 can thus function as a weighing apparatus in addition to other functions.

By means of the measurement the weight L_{M} of the load 11 is obtained by means of the formula (2), which can now be placed in the formula (6) with the other parameters that describe the operating mode of said stacker crane 1, so that it would be possible to calculate L_{TOT}, which should be the loading for example during acceleration/deceleration and during loading/unloading. If L_{M}′ measured in this situation is above or below the target value L_{TOT} within the set margin dL_{TOT}, which can exist in larger numbers as well, the control 20 gives an alarm on the under- or overloading. On the basis of the alarm it is possible to stop the system or perform predetermined measures.

If the set margin dL_{TOT} is large, it may be too late to amend the situation when an alarm is given. When the change rate of the measurement L_{M}′ is monitored, the alarm is usually given at an earlier stage. Thus, it is possible to react fast even though the load were light. For example a rapid change detected during a steady lifting or lowering movement may be an indication of vibration or collision.

Generally, the stacker crane functions in the following manner. At first the sensor readings are compensated in the control mode A, whereafter the spring constant K_{CH} of the lifting member 7 is determined (control mode B) as well as the maximum extensible length L_{MAX} of the same (control mode C). At the next stage it is possible to conduct a control mode D simultaneously with the normal operation of the stacker crane 1, in which control mode the weight L_{M} of the load 11 is determined. As the weight of the load 11 is now known, it is possible to monitor (control mode E) the operation during the movements of the stacker crane 1, wherein the calculated value L_{TOT} is compared to the allowed maximum and minimum values that have been set for example on the basis of the allowed maximum weight of the stacker crane 1. The values can also change dynamically according to the situation. The calculated value can also be compared to the value L_{M}. The total load measured on the basis of the elongation can also be compared as such to the set maximum and minimum values, wherein the effects of different factors do not have to be compensated separately to determine the weight L_{M} and to compare the same to the set values. If necessary, an alarm on the under- or overloading is given and the control means 20 function in the desired manner. The control modes are implemented in the control means by means of a program, wherein the information on the state of the stacker crane 1 obtained from the sensors 12, 13 is utilized. The necessary information on the position, speed and acceleration is obtained from the motor 2, and the lifting carriage 6 contains the necessary sensors for determining the position at a given moment.

The present invention is not limited solely to the above-presented and exemplified preferred embodiments, but it can be modified within the scope of the appended claims. The factors determined in the aforementioned formulas can be organized into a different format by mathematic measures, they can be scaled in the desired manner and combined to form a desired factor, wherein for example the spring constant of the lifting member can be changed for example into a function dependent on the stretching length.

1. A method in a stacker crane for weighing a load, which comprises:
a lifting carriage that is intended for handling of a load,
motor means which are arranged to lift and lower the lifting carriage,
a lifting member that transmits tensile stress and on the support of which the lifting carriage is suspended for movement and on which the motor means exert a tensile effect for the movement of the lifting carriage, and
first sensor means arranged to determine the position of the lifting carriage and generate a first signal that is proportional to said position,
control means connected to the first sensor means and the motor means to control the speed of the lifting carriage and to transfer the lifting carriage to the desired position,
second sensor means connected to the control means and arranged to generate a second signal that is proportional to the length of the lifting member that is fed via the motor means,
the method comprising the steps of:
determining the elongation of the lifting member, said elongation being caused by the load positioned in the lifting carriage that stretches the lifting member within the length between the lifting carriage and the motor means, said elongation being proportional to the difference of the first and second signal when the position of the lifting carriage is also determined on the basis of the second signal, and
determining the weight of the load on the basis of a calculation algorithm stored in the control means, said weight corresponding to the generated elongation, wherein in the calculation the stretching length of the lifting member between the lifting carriage and the motor means is taken into account in addition to the elongation of the lifting member, as well as a predetermined spring constant of the lifting member that indicates the elongation of the lifting member as a function of the loading and the stretching length.

2. The method according to claim 1, wherein the second sensor means are the sensor means that are placed in the motor means and arranged to generate a signal proportional to the speed of the lifting carriage, which signal is now also used as said second signal.

3. The method according to claim 1, further comprising the steps of:
compensating the effect of the weight of the lifting carriage and the effect of the other structures of the stacker crane in the determination of the elongation, in such a manner that the scaling between the first signal and the second signal is determined by transferring the unloaded lifting carriage to a first position that represents the lower limit of the movement range of the lifting carriage and by registering the signals, and by transferring the lifting carriage to a second position that represents the upper limit of the movement range of the lifting carriage and by registering the signals, and determining said scaling on the basis of a calculation algorithm and changes in the registered signal, and
determining the position of the lifting carriage by means of the second signal, in such a manner that the calculation is based on said scaling when the elongation of the lifting member is determined.

4. The method according to claim 1, further comprising the step of determining the weight of the load at the moment when the lifting carriage is stopped or in a steady movement.

5. The method according to claim 1, further comprising the steps of:
determining the calculatory total loading affecting the lifting member by means of a calculation algorithm, wherein in addition to the weight of the load the acceleration forces of the lifting carriage the weight of which is determined beforehand, and the acceleration forces of the load are taken into account, said acceleration forces being exerted on the lifting member and the elongation of the same, and
comparing the loading determined on the basis of the measurement of the elongation with the calculatory total loading, to find out whether the difference of these two is larger or smaller than the set one or more threshold values.

6. The method according to claim 1, further comprising the steps of:
determining the total loading affecting the lifting member by means of measurement of the elongation, from which total loading the effect of the weight of the lifting carriage which is determined beforehand and the acceleration forces of the load are compensated calculatorily, said acceleration forces being exerted on the lifting member and the elongation of the same, and
comparing the loading caused by the weight of the load to one or more threshold values, said loading being determined on the basis of compensation.

7. The method according to claim 5, further comprising the step of using the second sensor means for the measurement of acceleration, said means being placed in the motor means and arranged to generate a signal proportional both to the speed and acceleration of the lifting carriage, said signal being also used as said second signal.

8. The method according to claim 4, further comprising the step of correcting the weight and/or total loading by means of the calculatory loading effected by the loading of the stacker crane, said loading being proportional to the weight of the load and to the position of the load with respect to the stacker crane, when the load is supported in the lifting carriage.

9. The method according to claim 4, further comprising the step of correcting the weight and/or total loading by means of the calculatory loading effected by the prestressing of the lifting member, said loading being proportional to the determined elongation and to the predetermined spring constant of the spring members, when the stacker crane comprises spring members for prestressing, the shortening of said spring members corresponding to said elongation when the load is supported in the lifting carriage.

10. The method according to claim 5, further comprising the step of conducting continuously comparison during the operation of the stacker crane to detect under- or overloading and to generate a signal indicating the same.

11. The method according to claim 1, further comprising the step of comparing the change rate of the weight of the load and/or the total loading to one or more set threshold values continuously during the operation of the stacker crane to detect under- or overloading and to generate a signal indicating the same.

12. The method according to claim 1, further comprising the step of determining automatically the maximum extensible length of the lifting member, in such a manner that the elongation is determined in two different positions of the lifting carriage by transferring the load, the weight of which is as large as possible, by means of the lifting carriage to a first position and by registering the signals and transferring the load to a second position by means of the lifting carriage and by registering the signals, and by determining said length on the basis of the calculation algorithm and the registered signals in such a manner that the loading is substantially equal in different positions.

13. The method according to claim 1, further comprising the steps of:
determining automatically the spring constant of the lifting member, in such a manner that the elongation of the lifting member is registered when a load is positioned in the lifting carriage the weight and loading force of which is known, and
determining the spring constant of the lifting member on the basis of a calculation algorithm stored in the control means, said spring constant corresponding to the produced elongation, wherein in the calculation the stretching length of the lifting member between the lifting carriage and the motor means and the known weight of the load are taken into account in addition to the elongation.

14. The method according to claim 2, further comprising the steps of:
compensating the effect of the weight of the lifting carriage and the effect of the other structures of the stacker crane in the determination of the elongation, in such a manner that the scaling between the first signal and the second signal is determined by transferring the unloaded lifting carriage to a first position that represents the lower limit of the movement range of the lifting carriage and by registering the signals, and by transferring the lifting carriage to a second position that represents the upper limit of the movement range of the lifting carriage and by registering the signals, and determining said scaling on the basis of a calculation algorithm and changes in the registered signal, and
determining the position of the lifting carriage by means of the second signal in such a manner that the calculation is based on said scaling when the elongation of the lifting member is determined.

15. The method according to claim 6, further comprising the step of using the second sensor means for the measurement of acceleration, said means being placed in the motor means and arranged to generate a signal proportional both to the speed and acceleration of the lifting carriage, said signal being also used as said second signal.

16. The method according to claim 6, further comprising the step of conducting continuously comparison during the operation of the stacker crane to detect under- or overloading and to generate a signal indicating the same.

17. A stacker crane and a system for weighing a load, comprising:
a lifting carriage that is intended for handling of a load,
motor means which are arranged to lift and lower the lifting carriage,
a lifting member that transmits tensile stress and on the support of which the lifting carriage is suspended for movement and on which the motor means exert a tensile effect for the movement of the lifting carriage, and
first sensor means arranged to determine the position of the lifting carriage and generate a first signal that is proportional to said position,
control means connected to the first sensor means and the motor means to control the speed of the lifting carriage and to transfer the lifting carriage to the desired position,
second sensor means connected to the control means and arranged to generate a second signal that is proportional to the length of the lifting member that is fed via the motor means,
the control means are arranged to determine the elongation of the lifting member which is caused by the load positioned in the lifting carriage that stretches the lifting member within the distance between the lifting carriage and the motor means, said elongation being proportional to the difference of the first and second signal when the position of the lifting carriage is determinable on the basis of the second signal, and
a calculation algorithm is stored in the control means by means of which the weight of the load is determined, said weight corresponding to the produced elongation, wherein the stretching length of the lifting member between the lifting carriage and the motor means and a predetermined spring constant of the lifting member, indicating the elongation of the lifting member as a function of the loading and the stretching length, are included in the calculation in addition to the elongation.

18. The stacker crane and system according to claim 17, wherein the second sensor means comprise the sensor means that are placed in the motor means and arranged to generate a signal proportional to the speed of the lifting carriage, which signal is also proportional to the position of the lifting carriage.

19. The stacker crane and system according to claim 17, wherein the control means are arranged to continuously compare the weight of the load and/or the total loading caused by the same to one or more threshold values to detect under- or overloading and to generate a signal indicating the same.

20. The stacker crane and system according to claim 18, wherein the control means are arranged to continuously compare the weight of the load and/or the total loading caused by the same to one or more threshold values to detect under- or overloading and to generate a signal indicating the same.
